(19) United States
(12) Patent Application Publication
(10) Pub. No.: US 2001/0045055 A1
(43) Pub. Date: Nov. 29, 2001

(54) Plastic net for farming

(76) Inventor: Tsung-Chin Wu, Chang-Hua City (TW)

Correspondence Address: JENQ LONG PLASTIC INDUSTRY CO., LTD., PO BOX 487, Chang-Hua City, 500, TW

(21) Appl. No.: 09/860,535

(22) Filed: May 21, 2001

(30) Foreign Application Priority Data
May 23, 2000 (DE) 200 09 247.2

(51) Int. Cl. A01C 1/00; A01G 1/00

(52) U.S. Cl. 47/1.01 R

(57) ABSTRACT

A plastic net for farming comprises at least three layers with both ends sealed being formed by weaving in which each of the sealed ends is cut to separate the top layer from one sealed end and the bottom layer from the other sealed end respectively. Such continuous plastic net can provide a good protection to plants grown there in.

### FIELD OF THE INVENTION

The present invention relates to plastic nets and more particularly to a plastic net for farming with improved characteristics.

### BACKGROUND OF THE INVENTION

Conventionally, a large net for farming is formed by stitching a plurality of small nets together. However, the stitched portion between two adjacent small nets is subject to break since net is formed of plastic material and the stitching is not good. Such broken plastic net may neutralize the protection on for example, plants. Thus improvement exists.

### SUMMARY OF THE INVENTION

It is therefore an object of the present invention to provide a plastic net for farming comprising at least three layers with both ends sealed being formed by weaving wherein each of the sealed ends is cut to separate the top layer from one sealed end and the bottom layer from the other sealed end respectively. Such continuous plastic net can provide a good protection to plants grown there in.

The above and other objects, features and advantages of the present invention will become apparent from the following detailed description taken with the accompanying drawings.

### BRIEF DESCRIPTION OF THE DRAWINGS

FIG. 1 is a side view of a preferred embodiment of plastic net for farming according to the invention where plastic net is laminated and sealed to both ends in the manufacturing process;

FIG. 2 is a view similar to FIG. 1 where sealed portions are cut; and

FIG. 3 is a perspective view of the fully extended FIG. 2 plastic net in a use state.

### DETAILED DESCRIPTION OF THE PREFERRED EMBODIMENTS

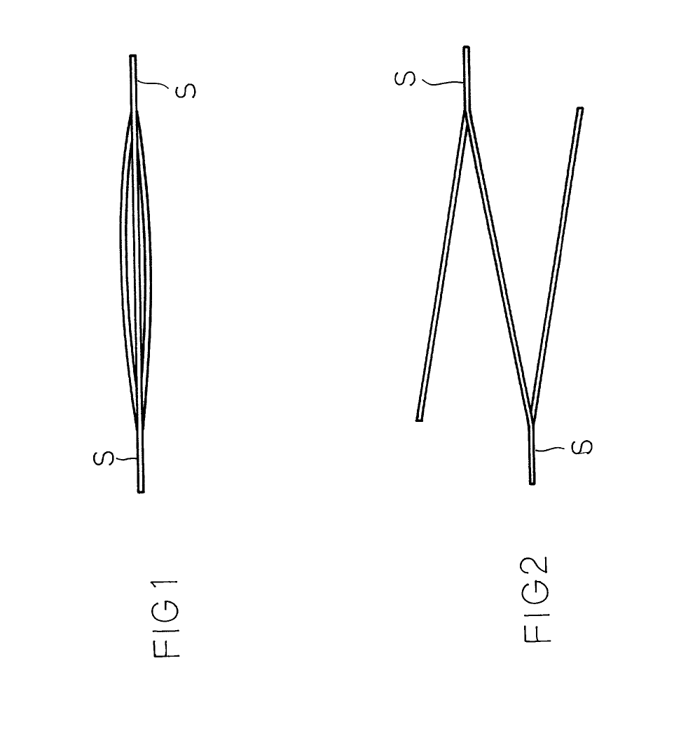

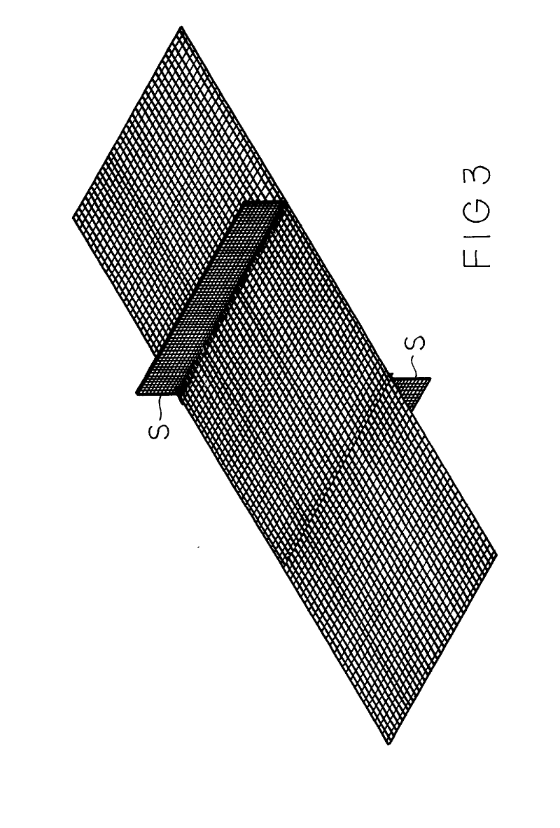

Referring to FIG. 1, there is shown a three-layer plastic net for fanning in accordance with the invention in a laminated state in the manufacturing process. Such plastic net is formed by a plain weave with both ends S sealed completely. Then a cutting is performed on sealed portions S to separate the top layer net from the left sealed portion S and the bottom layer net from the right sealed portion S respectively. This forms a finished plastic net as shown in FIG. 2. Note that the plastic net is not limited to be consisting of three layers. More layers are possible depending on applications. Referring to FIG. 3, the FIG. 2 plastic net is fully extended. Since the sealed portions S are sealed completely by a weaving process the drawback of plastic net break as experienced in prior art is eliminated. Hence, plants covered by such plastic net are well protected.

While the invention has been described by means of specific embodiments, numerous modifications and variations could be made thereto by those skilled in the art without departing from the scope and spirit of the invention set forth in the claims.

What is claimed is:

1. A plastic net for farming comprising at least three layers with both ends sealed being formed by weaving wherein each of said sealed ends is cut to separate said top layer from one sealed end and said bottom layer from the other sealed end respectively.
